(19) United States
(12) Patent Application Publication
(10) Pub. No.: US 2003/0044750 A1
(43) Pub. Date: Mar. 6, 2003

(54) Implant depth calibration device

(76) Inventors: Richard J. Deslauriers, Woodbury, CT (US); Robert T. Potash, South Windsor, CT (US); Leonard Infranco, Lawrenceville, NJ (US); Stephanie Bonin, East Hartford, CT (US)

Correspondence Address: Richard J. Deslauriers, M.D., 50 Altair Avenue, Plymouth, CT, 06782, US

(21) Appl. No.: 09/946,697

(22) Filed: Sep. 4, 2001

(51) Int. Cl. A61C 19/04

(52) U.S. Cl. 433/72

(57) ABSTRACT

A radiographic guide being comprised of a first material and a second radio-opaque material, and further comprises a top and bottom surfaces having grooves providing for a means of securing said guide in a stable position in a patient's bite path, and wherein said second material may comprise a calibration template, wherein said template comprises four calibration means of varying height and being disposed of within said first material. The calibration template of said radiographic guide may be displayed in a panoramic x-ray film and may further provide for a self-contained calibration system for determining the actual distance from a patient's gum line to a nerve or sinus of a patient from a distorted distance from said patient's gum line to a nerve or sinus depicted in said panoramic x-ray film.

### BACKGROUND OF THE INVENTION

1. Field of the Invention

This invention relates to the field of dental implants, and more particularly to devices and methods for the calibration of the location and depth of dental implants.

2. Description of the Related Art

Individuals may require a dental implant due to the removal of an existing tooth or a missing tooth. The implanting of a prosthetic tooth may require the implantologist to secure a post or abutment to the patient's jaw, and where a crown or synthetic tooth may then be secured to the exposed portion of the post. In this process of securing the post to the patient's jaw, the dentist may be required to take x-rays of the patient's mouth to determine the location for the insertion of the replacement tooth. Specifically, the x-ray films may provide the doctor with a depiction of the patient's gum line, and in particular, the location of the dental nerve and sinuses located within the patient's jaw.

The determination of the exact location of the dental nerve and sinuses is important, as the doctor is required to insert the post into the patient's jaw, such that the implant may be placed deep enough into the jaw to provide adequate lateral strength for the implant. However, the doctor must use care, so as not to cause any damage to the nerves or sinuses, during both boring the implant site as well as the insertion of the implant. In this process of determining the location of the dental nerve, the doctor may take a series of panoramic x-rays of the patient, and wherefrom the doctor may estimate the location of the nerve in the jaw relative to the gum line, and with respect to the curvature of the patient's jaw.

However, there is a significant drawback in the determination of the exact depth and location of the nerve and sinuses when based upon panoramic x-ray films. The reason for the difficulty is that the taking of the panoramic x-ray, which provides for one x-ray film depicting the entire row of teeth, distorts the scale and size of the patient's jaw on the x-ray film. This distortion of the scale increases the difficulty in precisely determining the depth of the nerve quickly, as the doctor may be required to make approximations of the depth by taking a series of x-rays, while progressively boring a hole to a depth that approaches the nerve without causing any damage or trauma.

### BRIEF SUMMARY OF THE INVENTION

Therefore a need has arisen for a radiographic implant depth calibration device that overcomes these and other shortcomings of the related art.

A technical advantage of the present invention is that this device may provide for rapid panoramic x-ray film calibration through the use of a radio-opaque calibration template. Another technical advantage of the present invention is that an x-ray may be taken of the patient that provides for a measuring system that may permit the exact determination of the location of the nerve relative to the patient's gum line. Another technical advantage is to provide for an inexpensive device that may be discarded between uses so as to promote sterility and prevent the transmission of bacteria and diseases between patients.

According to an exemplary embodiment a radiographic guide is described, which may be comprised of a first material and second material, wherein said first material may comprise a top surface and a bottom surfaces, wherein said top surface and said bottom surface may comprise a groove, wherein said grooves provide a means for placing a top and bottom row of teeth, whereas a means of securing said guide in a stable position in said patient's jaw may be provided. The second material of said guide may be comprised of a radio-opaque material, wherein said radio-opaque material may be comprises a radio-opaque calibration template, wherein said calibration template further comprising a measuring means, wherein said measuring means may comprise bars of varying, and whereby said calibration template may be depicted in an x-ray film.

Furthermore according to a preferred method of use, said radiographic grid may provide for a self-contained calibration system for determining an actual distance from a patient's gum line to a nerve or sinus of a patient's jaw from a distorted distance of a patient's gum line to a nerve or sinus depicted in a panoramic x-ray film.

Other objects, features, and advantages will be apparent to persons of ordinary skill in the art in view of the following detailed description of the invention and the accompanying drawings.

### BRIEF DESCRIPTION OF THE SEVERAL VIEWS

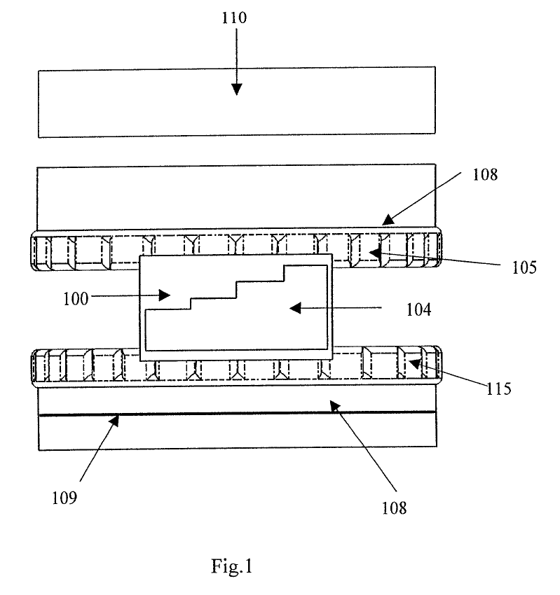

FIG. 1 shows a front view of the preferred embodiments of the radiographic calibration guide.

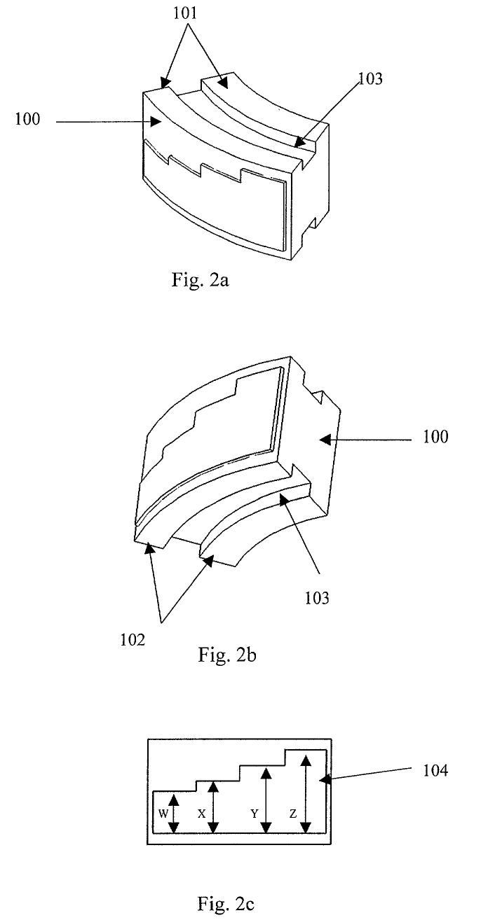

FIG. 2a. shows a top perspective view of the preferred embodiments of the radiographic calibration guide.

FIG. 2b shows a bottom perspective view of the preferred embodiments of the radiographic calibration guide.

FIG. 2c shows a front view of the preferred embodiments of the radio-opaque calibration template

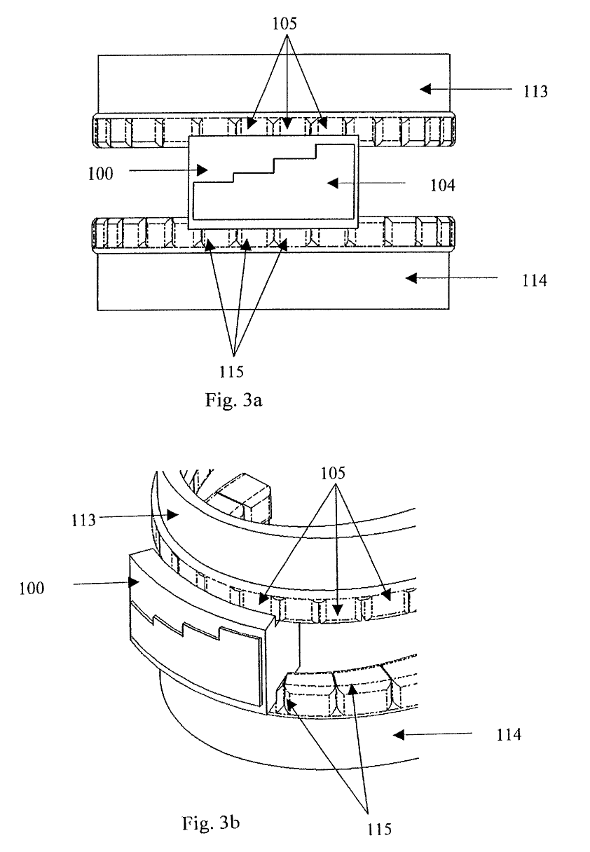

FIG. 3a shows a top perspective view of the preferred embodiments of the radiographic calibration guide according to a preferred method of use.

FIG. 3b shows a front view of the preferred embodiments of the radiographic calibration guide according to a preferred method of use

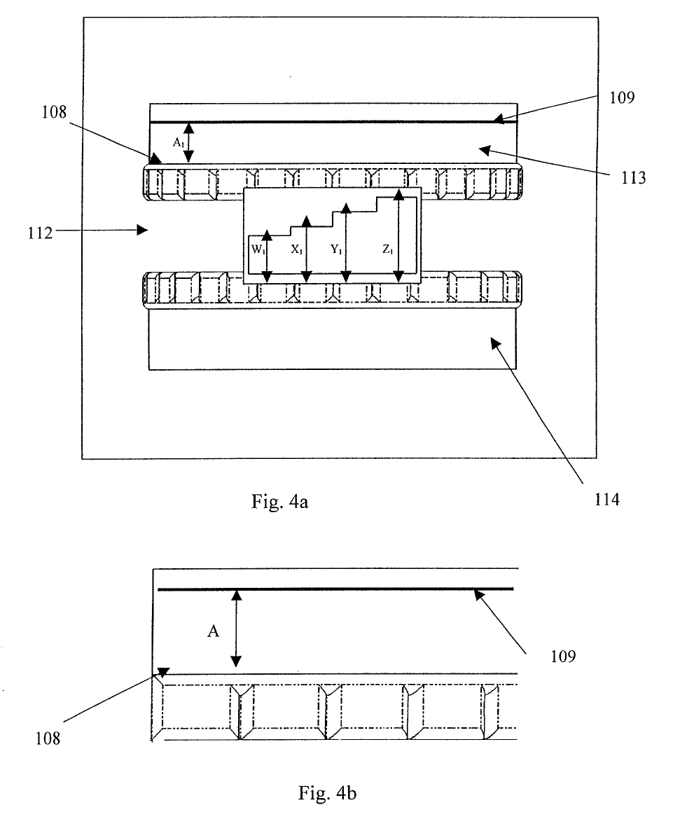

FIG. 4a depicts a x-ray film of the preferred embodiments of the calibration template according to a preferred method of use.

FIG. 4b depicts a front view of a maxilla according to a preferred method of use.

### DETAILED DESCRIPTION OF THE INVENTION

Preferred embodiments of the present invention and their advantages may be understood by referring to FIGS. 1-4b, like numerals being used for like corresponding parts in the various drawings.

Referring to FIGS. 1-2c, radiographic guide 100 is depicted. In an embodiment of the present invention, radiographic guide 100 may provide for a self-contained calibration template 104 for determining the distance from a patient's gum line 108 to a nerve 109 or sinus 110 determined in an x-ray film to the actual distance from said patient's gum line 108 to a nerve 109 or sinus 110.

Guide 100 may be comprised of a first material and a second material, wherein said first material may be designed, whereby said design permits a secure fit along the bite path of a patient. In a preferred embodiment said first material may be parabolicly shaped following the curvature of a patient's jaw. In another embodiment, said first material may be substantially linear, whereby said guide may fit securely along the side of a patient's bite bath. Guide 100 may further comprise a top surface 101 and bottom surface 102, wherein top surface 101 and bottom surface 102 may have grooves 103. In a preferred embodiment, grooves 103 may provide for a means of securing guide 100 in a stable position in a patient's jaw between a maxilla 113 and mandible 114.

Guide 100 further comprising a second radio-opaque material, wherein said radio-opaque material may depict a calibration template 104. In a preferred embodiment, calibration template may be comprised of one or more bars, wherein said bars may have known dimensions providing for a height. Referring to FIG. 2c, a preferred embodiment of calibration template 104 is shown, wherein calibration template 104 may be a series of bars having heights W, X, Y, and Z. Specifically, in a preferred embodiment calibration template 104, height W may be about 8 mm, height X may be about 10 mm, height Y may be about 13 mm, and height Z may be about 16 mm. In this embodiment, the incorporation of a series of bars may facilitate the determination of an actual distance from a distorted distance through direct comparison. In other embodiments, calibration template may be comprised of any predetermined height.

In an embodiment, calibration template 104 may be imprinted on a radio-opaque sticker that may depict a series of bars of varying heights, and wherein sticker 105 may be manufactured from lead foil. Furthermore, said sticker may be disposed of within said first material, or alternatively, said sticker may be placed on the exterior surface of said first material. Furthermore according to another embodiment, calibration template 104 may be manufactured of barium sulfate, and disposed of within said first material comprising guide 100, and wherein said radio-opaque material may be layered into said first material during the manufacturing process in varying height wherein calibration template may be formed.

Referring to FIGS. 3a-4b, a preferred method of determining the size and location for a dental implant is shown. First, radiographic guide 100 comprising calibration template 104 may be inserted upright into a patient's mouth between upper teeth 105 and lower teeth 115. Guide 100 may be secured upon the patient holding guide 100 with top teeth 105 and bottom teeth 115, such that occlusal surfaces of teeth 105 and teeth 115 rest in grooves 103 on the top surface 102 and bottom surface 103 of guide 100.

A panoramic x-ray may then be taken while guide 100 is between teeth 105 and teeth 115. After the x-ray is taken guide 100 may be removed from patient's mouth and discarded. The resulting x-ray film 112 may then depict guide 100 along with imprinting calibration template 104, gum line 108, sinus 109, nerve 110, maxilla 113, and mandible 114, wherein the imprinted of calibration template 104 onto panoramic radiograph may provides a means to have reference points measured to determine an actual distance through direct comparison of two distorted distance, wherein an actual distance of only one of said distorted distances is known.

An actual distance A, shown in FIG. 4b, may be determined through the direct comparison of a distorted length of radio-opaque bars W₁, X₁, Y₁, and Z₁ in panoramic x-ray film 112 to distance A₁ in x-ray film 112, wherein height W, X, Y, and Z is known. For example, where A₁ may be approximately equal to W₁, then A may be approximately equal to W, and whereby actual distance W may be 8 mm then distance A may equal 8 mm. In another embodiment a conversion ratio may be determined. For example, where there is an original length W of template 104 is about 8 mm and the x-ray film length W₁ of grid 104 is about 6 mm, then said conversion ratio may be W/W₁, or 8/6, (e.g. x-ray film measurement multiplied by 1.333). Therefore, if x-ray film distance A₁ from gum line 108 to nerve 110 is about 7 mm, then actual distance A from gum line 108 to nerve 110 may be about 9.331 mm.

The method wherein said ratio may provides for the determination of the distance of nerve 110 and sinuses 109 in a subject's maxilla 113 from the patient's gum line 108, wherein said actual distance provides for the drill depth for inserting a dental implant. In another embodiment of the method described above, the determination of the distance of nerves 110 and sinuses 109 in a subject's mandible 114 from the patient's gum line 108 may be determined, wherein said actual distance provides for the drill depth for inserting a dental implant.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in art from a consideration of the specification or practice of the invention disclosed herein.

What is claimed is:

1. A radiographic implant depth guide being comprised of:
a first material and a second radio-opaque material,
wherein said radio-opaque material comprises a calibration template, wherein said template comprises an at least one calibration means having known dimensions.

2. The guide of claim 1, wherein said guide follows the contours of a patient's bite path.

3. The guide of claim 1, wherein said first material is selected from one of the group consisting of a plastic or a rubber.

4. The guide of claim 3, wherein said first material is water-soluble.

5. The guide of claim 1, wherein said guide further comprises a top surface, wherein said top surface comprises a groove for the occlusal surfaces a patient's teeth.

6. The guide of claim 1, wherein said guide further comprises a bottom surface, wherein said bottom surface comprises a groove for the occlusal surfaces a patient's teeth.

7. The guide of claim 1, wherein said second material is selected from one of the group consisting of lead foil, stainless steel, or barium sulfate.

8. The guide of claim 1, wherein said calibration template is manufactured into, and further, disposed of within said first material.

9. The guide of claim 1, wherein said calibration template is manufactured on an exterior surface of said first material.

10. The guide of claim 7, wherein said calibration template is imprinted onto a sticker.

11. The guide of claim 1, wherein said calibration template is attachable to and removable from said first material.

12. The guide of claim 1, wherein said calibration template comprises four calibration means.

13. The guide of claim 11, wherein the height of a first means is about 8 mm.

14. The guide of claim 11, wherein the height of a second means is about 10 mm.

15. The guide of claim 11, wherein the height of a third means is about 13 mm.

16. The guide of claim 11, wherein the height of a fourth means is about 16 mm.

17. The guide of claim 1, wherein said calibration template provides for a method of determining the location and depth of an implant through a direct comparison of a known distance to the distance from a patient's gum line to a nerve or sinus.

18. The guide of claim 1, wherein said calibration template provides for a self-contained calibration system for determining the ratio to convert an x-ray film distance from a patient's gum line to a nerve or sinus of a patient's jaw to the actual distance from said patient's gum line to a nerve or sinus.

19. A guide being comprised of:
a first material; and
a second radio-opaque material,
wherein said first material follows the curvature of a patient's bite path, wherein said first material further comprises a top surface and a bottom surface, wherein said top surface and said bottom surface comprises grooves, and wherein said second material comprises calibration template, wherein said calibration template comprises four calibration means of varying height and is disposed of within said first material.

20. The guide of claim 19, wherein the height of said first means is about 8 mm.

21. The guide of claim 19, wherein the height of said second means is about 10 mm.

22. The guide of claim 19, wherein the height of said third means is about 13 mm.

23. The guide of claim 19, wherein the height of said fourth means is about 16 mm.

24. A method of determining the size and location of a dental implant with the guide of claim 1 comprising the steps:
Placing said guide into the patient's mouth upright, wherein said patient's top and bottom teeth rest in grooves on the top and bottom surfaces of said guide;
Taking a panoramic x-ray while said guide is between teeth;
Removing said guide from said patient's mouth and discarding said radiographic guide; and
Said radio-opaque calibration template is imprinted onto a panoramic x-ray film, wherein said imprint provides a means to have reference points measured and compared on said panoramic x-ray film.

25. The method of claim 24, wherein an actual distance from a gum line to a nerve or sinus of a subject's maxilla is determined through the direct comparison of the distorted dimension of said calibration template in said panoramic x-ray film to the distorted distance from said gum line to said nerve or sinus in said panoramic x-ray film, wherein the actual dimension of calibration template is known.

26. The method of claim 24, wherein an actual distance from a gum line to a nerve of a subject's mandible is determined through the direct comparison of the distorted dimension of said calibration template in said panoramic x-ray film to the distorted distance from said gum line to said nerve in said panoramic x-ray film, wherein the actual dimension of calibration template is known.

27. The method of claim 24, wherein a conversion ratio is provided for the determination of the distance of nerves and sinuses in a subject's maxilla from the patient's gum line.

28. The method of claim 24, wherein a conversion ratio is provided for the determination of the distance of nerves in a subject's mandible from the patient's gum line.
